(19) United States
(12) Patent Application Publication
(10) Pub. No.: US 2014/0077647 A1
(43) Pub. Date: Mar. 20, 2014

(54) GENERATOR DEVICE USING PERMANENT MAGNETS

(71) Applicant: Harry Vivier, Paris (FR)

(72) Inventor: Harry Vivier, Paris (FR)

(21) Appl. No.: 13/265,004

(22) PCT Filed: May 3, 2010
(86) PCT No.: PCT/FR2010/000341

§ 371 Date: Dec. 14, 2011

(30) Foreign Application Priority Data
May 4, 2009 (FR) 09/02125

(51) Int. Cl. H02K 21/02

(52) U.S. Cl. 310/152

(57) ABSTRACT

The invention relates to a device characterised in that said device is made of the assembly of a plurality of microgenerators, each including a magnetic circuit as a loop of segments for the insertion of a winding of turns of copper wire (3) and the application thereof against the inclined planes (7) of magnet segments (F, G) with axial magnetisation and segments made of a material with good magnetic conductivity, such as soft iron, combined to create said magnetic loop circuit expressed by the magnetic field inside said segments (D, F, G), and in which the magnetic field lines act on said winding in order to create an electric voltage at the ends of said copper wire, the segments (D, F, G) being enclosed in a frame (8), such that each microgenerator is unitary.

The object of the invention is to produce household electricity continuously, anywhere in this world, and without consuming any energy materials such as coal, oil, gas, or using the intermittent energy provided by the wind and the sun.

The invention is an application of one of the discoveries of the present inventor and author of the work “Esprit-Cristal en Zoncalm”.

In the work, it is said that the magnetic field of a magnet produces a flow of “fundamental fluid”. To stay in the vocabulary of magnetism, we will say “magnetricity”, which, usually, is produced by lines of force of a magnetic field.

The invention answers the question: How to produce domestic electricity with static magnets?

Below, the invention is described using drawings described chronologically.

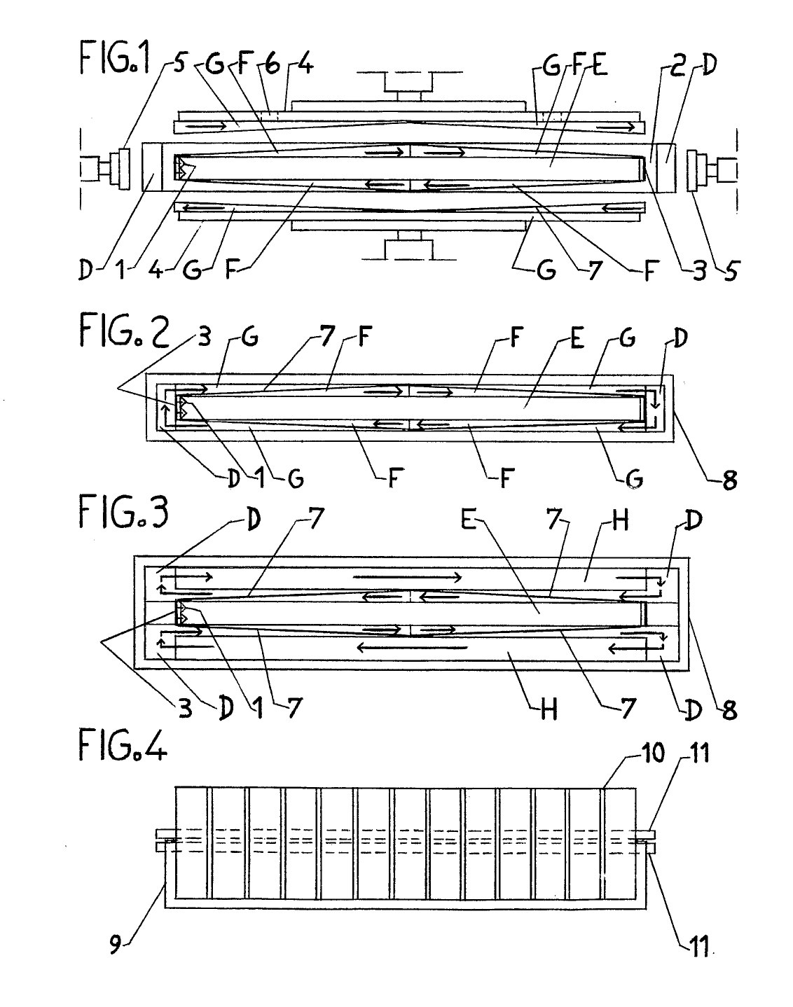

FIG. 1 is an implementation schematic of a microwave generator comprising segments D having good magnetic conductivity, such as soft iron, and segments F, G made of axially magnetized magnet, the opposing segments being separated by a nonmagnetic spacer E pierced in 1. The loop magnetic circuit formed by segments enables the introduction of a winding of copper wire 3 and its application against the inclined planes 7 of segments F, G associated with the segment D to create a magnetic field in the interior of the aforementioned segments and whose lines of force acting on the aforementioned winding in order to create an electrical voltage at the ends of the aforementioned copper wire. By their magnetism, the segments F adhere on the ferrous inserts or magnets in the plate 2, and all the segments, including the spacer E, were brought onto the plate by robot grippers. The plate is on a rotating carousel stepper to be positioned under a winding device unwinding a copper wire 3 diameter 0.15 to 0.20 mm made of an electrical insulator by a varnish in order to surround the segments F of a winding of turns of the aforementioned wire. Another rotation of the carousel positions the plate between the four hydraulic cylinders having the end of their piston joined to a frame bar 4, 5 with vertical sliding supported on springs. Each nonmagnetic bar 4 comprises ferrous inserts 6 for a light magnetic adherence of segments G advancing to be applied on the aforementioned turns along the inclined planes 7 of segments F, G and together with the advance of bars 5 pushing the segment D made of soft iron.

FIG. 2 is the schematic of the assembly of the single-piece micro generator by a frame made of polymer 8 lowered by a jack on the bars 4, 5 substituting there in order to enclose, with the spacer E, the segments of the magnetic circuit D, F, G. The spacer E separates the opposing segments and comprising inclined planes 7 supporting a length of the winding, and the openings 1 receive the ends of the copper wire 3 and two distinct copper rods in preparation for the electrical connection of a plurality of micro-generators.

FIG. 3 is a variant of the single-piece permanent micro generator concept with static magnets comprising a loop magnetic circuit linking segments made of magnet having axial magnetization and segments made of a material having good magnetic conductibility, such as soft iron. In this variant of linking, the segment made of soft iron D is looped with the magnet H while being split, so as to obtain inclined planes 7 supporting a length of the winding of wire 3. In implementation example, the magnets H has a thickness of 6 mm and a width of 8 mm, equal to a cross-section of 6×8 mm that is double of that of the segment of soft iron D having a cross-section of 3×8 mm in its longitudinal part, enclosing turns of the aforementioned winding applied on the inclined planes 7.

FIG. 4 shows one half of housing 9 connecting a plurality of microwave generators side by side and interleaved with an electrical insulator made of pierced sheet 10 while being integral with the spacers E for the connection of a plurality of electrical generators by copper rods in the openings 1, as specified in FIGS. 1, 2, 3.

1. Permanent generator device producing domestic electricity using static magnets, characterized in that it is formed from the connection of a plurality of micro-generators, each comprising a magnetic circuit made of a loop of segments for the introduction of a winding of turns of a copper wire and its application against the inclined planes of segments made of magnet having axial magnetization and segments made of a material having good magnetic conductibility, such as soft iron, linked to create the aforementioned magnetic loop circuit produced by the interior magnetic field of the aforementioned segments, and whose lines of force act on the aforementioned winding in order to create an electric voltage at the ends of the aforementioned copper wire, the segments being enclosed by a frame, such that each micro generator is single-piece.

2. Device, according to claim 1, characterized in that a non-magnetic spacer separates the opposing segments comprising inclined planes supporting a length of the winding, and it is integral with an electrical insulator sheet, both pierced to receive the ends of the wire and two distinct copper rods for the electrical connection of a plurality of micro-generators.
